(19) United States
(12) Patent Application Publication
(10) Pub. No.: US 2024/0284004 A1
(43) Pub. Date: Aug. 22, 2024

(54) Systems and Methods for Streaming Content Items based on User-Selectable Characteristics and User Feedback

(71) Applicants: Oleg E Panteleev, Waltham, MA (US); Ekaterina V Panteleev, Waltham, MA (US)

(72) Inventors: Oleg E Panteleev, Waltham, MA (US); Ekaterina V Panteleev, Waltham, MA (US)

(21) Appl. No.: 18/307,766

(22) Filed: Apr. 26, 2023

(51) Int. Cl. H04N 21/454; G06F 16/953

(52) U.S. Cl. CPC H04N 21/454; G06F 16/953

(57) ABSTRACT

Systems and methods are provided for selecting streaming items of content based on characteristics selected by users and based on feedback from users. The systems and methods presented comprise hardware architecture, computer-implemented processes, and instructions stored in non-transitory computer-readable media configured to carry out the processes for selecting streaming items of content based on characteristics selected by users and based on feedback from users. A user may use the systems and methods to select characteristics for, and to provide feedback on, content items. The present invention solves problems with the currently available systems and methods of selecting streaming items of content based on characteristics selected by users and based on feedback from users. The system and methods improve on the present art of playlists, and on the present art of selections of streaming content.

### FIELD OF THE INVENTION

The present disclosure relates generally to systems and methods for selecting streaming items of content to stream, and more specifically, to selecting streaming items of content based on characteristics selected by users and based on feedback from users.

### BACKGROUND OF THE INVENTION

Streaming of content items is established, with multiple platforms existing for streaming of music or other audio, videos, movies, and more types and items of content. In the present art, content items are streamed to a user, one of a plurality of users, based on algorithmic selections for characteristics of the content items, wherein the algorithmic selections are made by the platform which is streaming the content items to the user. A need exists for greater user-selectable control over the characteristics of streaming items streamed to a user.

### SUMMARY OF THE INVENTION

The present invention meets all these needs, by disclosing systems, and methods, and instructions stored in non-transitory computer-readable media for selecting streaming items of content based on characteristics selected by users and based on feedback from users.

The present invention addresses the problems of the prior art, which do not present systems and methods for selecting streaming items of content based on characteristics selected by users and/or based on feedback from users. The present invention also provides for multiple types of characteristics of the items to be streamed, such that the user can select one or more characteristics, and within each selected characteristic, the user can select and/or deselect multiple keywords for the desired content items. The systems and methods of the present disclosure further allow for users to report feedback on the characteristics they've tagged. The systems and methods of the present disclosure teach streaming content items based on the user-selected characteristics, and/or on content items that the user (any particular user) has previously rated highly or poorly. While playlists exist and are well-established, playlists are not user-configurable based on user-settable criteria, rather, playlists require either user interaction to choose and order songs in the playlist, or utilize selections based on content items that others who have chosen or liked a particular item of content have liked or chosen. The present invention improves on the user experience, useability, and functionality of playlists, by allowing users to set multiple criteria to be used to select content to stream.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter. The terms “approximate” or “approximately” and similar conjugates mean, for purposes of this disclosure, values within 10% of each other or within 10% of a specified value or end-values of a range of values. The singular and plural are interchangeable and a term in the singular includes the plural, or vice-versa, unless such reading is contradicted by the context. Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

### BRIEF DESCRIPTION OF THE DRAWINGS

The foregoing summary, as well as the following detailed description of various aspects, is better understood when read in conjunction with the appended drawings. For the purposes of illustration, the drawings show exemplary aspects; but the presently disclosed subject matter is not limited to the specific methods and instrumentalities disclosed. In the drawings, like reference characters generally refer to the same components, or steps of the methods, throughout the different figures. In the following detailed description, various aspects of the present invention are described with reference to the following drawings, in which:

FIG. 1 presents an exemplary system diagram of the present disclosure.

FIG. 2 presents a possible user interface of the present disclosure.

FIG. 3 presents a flowchart of a method performed by the system of FIG. 1 according to an aspect of the present invention.

FIG. 4 presents a dataflow diagram of a system of the present disclosure.

### DETAILED DESCRIPTION OF THE DRAWINGS

The presently disclosed invention is described with specificity to meet statutory requirements. But, the description itself is not intended to limit the scope of this patent. Rather, the claimed invention might also be configured in other ways, to include different steps or elements similar to the ones described in this document, in conjunction with other present or future technologies. Moreover, although the term “step” or similar terms may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the apparatus and methods of use of the present invention.

In one aspect, at a high level of overview, the systems and methods of the present disclosure comprise streaming items of content based on characteristics selected by users and/or based on feedback from users. As used herein, “streaming” includes, but is not limited to, sending one or more content items for display, playback, presentation, reading, text-to-speech, listening, and/or other types of presentation to one or more users. The present invention improves on the user experience, useability, and functionality of both playlists and of the present art of streaming content. Playlists are not user-configurable based on user-settable criteria, rather, playlists require either user interaction to choose and order songs in the playlist, or utilize selections based on content items that others who have chosen or liked a particular item of content have liked or chosen. The present invention improves on the user experience, useability, and functionality of playlists, by allowing users to set multiple criteria to be used to select content to stream

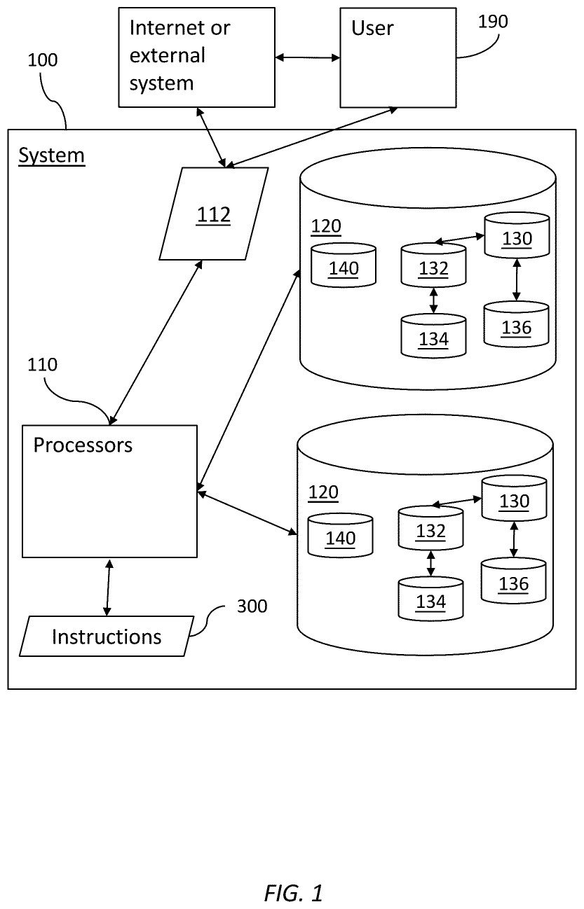

The present invention comprises a system 100, methods, and non-transitory, computer-readable media comprising instructions, for selecting streaming items of content based on characteristics selected by users and/or based on feedback from users, in any combination of such characteristics and such feedback. With reference to FIG. 1, the system 100 comprises a plurality of processors 110, a plurality of input/output modules 112; and a plurality of databases 120. The plurality of databases 120 comprise a plurality of content items 130, and a plurality of characteristics 132, and a plurality of user-content records 136. The plurality of processors 110 is communicably connected with the plurality of input/output modules 112 and the plurality of processors 110 is communicably connected with the plurality of databases 120. The system 100 may be operated by an owner of the plurality of content items 130, in some aspects of the present disclosure. In other aspects, the system 100 may be operated by an operator of a streaming service, such an operator being an entity operating a service that desires to stream a plurality of content items 130 selectable by a user 190 or more than one user 190. Such an operator may be a website operator, a radio station that broadcasts over radio waves, an Internet radio station, a video or audio streaming operator, a provider of podcasts, photographs, or audiobooks, a social media platform, or another type of provider of a plurality of content items 130.

The plurality of characteristics 132 are associated with the plurality of content items 130, such that each one of the plurality of content items 130 may have any of a number of the plurality of characteristics 132. The plurality of characteristics 132 are information about or related to each of the plurality of content items 130. The plurality of characteristics 132 may include, but are not limited to, types of content items 130: music, videos, animations, movies, news articles, any written works, social media posts, audio content, podcasts, audiobooks, photographs, or other types of content. The plurality of content items 130 may comprise any of the foregoing types of content, or other types of content. The plurality of characteristics 132 may include, but are not limited to, descriptors of one or more of the plurality of content items 130, such as the category; genre; artist/author name(s); artist/author gender(s); artist/author age(s); languages—particular languages, and/or a number of languages in the plurality of content items 130, whether the number desired is an exact match, or a range, or greater or fewer than a particular number; mood; tempo; instrumentation; vocals or not; duration; length; year or year range made, written, and/or created, quality of the plurality of content items 130; written format; length; whether the plurality of content items 130 includes pictures, video, and/or audio; content designated as violent, pornographic, and/or other graphic content; type of creator; and other descriptors. For each of the plurality of characteristics 132 described herein, each of the characteristics may include any such items now known or later invented, and may be or comprise any combination of the plurality of characteristics 132. For each of the plurality of characteristics 132 described herein, any of a number of keywords 134 are possible. The any number of keywords 134 may be comprised in the plurality of databases 120. Without limiting the number of keywords 134 which are possible, examples of selected keywords include the following. For category of content, possible keywords include but are not limited to music, video, tv show, movie, news story, animation, podcast, audiobook, radio broadcast, article, photographs, blog posts, and social media posts. For genre, possible keywords include but are not limited to pop, rock, hip hop, electronic, instrumental, retro, lounge, alternative, country, classical, jazz, and more. For language of the plurality of content items 130, possible keywords include but are not limited to: English, Spanish, French, Russian, German, Japanese, Korean, Chinese, Arabic, Swahili, Hindi, and more, including any language now known or later invented. For instrumentation, possible keywords include but are not limited to guitar, bass, drums, synth, piano, strings, woodwinds, vocals, choral, brass, and more. For tempo, possible keywords include but are not limited to any of a range of tempos or particular tempos may be selected, in particular and without limiting the foregoing, the most popular tempos are from approximately 40 beats per minute (bpm) to approximately 200 bpm. For quality of the plurality of content items 130, possible keywords include but are not limited to: compression, file format, lossless, and more. For written format, possible keywords include but are not limited to article, explainer, infographic, blog post, and more. For length of a written work, possible keywords include but are not limited to ranges or page counts or word counts, or other measures. For length or duration of the plurality of content items 130, possible keywords include but are not limited to: time ranges, longer or shorter than, with margins that may be exact or flexibly expressed in ranges or percentages, or other measures. For type of creator, possible keywords include but are not limited to professional, self-produced, crowd-sourced, open-sourced, social media posts or shares, or other ways content is created.

Each of the plurality of content items 130 may be tagged, i.e., associated with, any of a number of keywords 134, from 0-n, in each of the plurality of characteristics 132. For each of the plurality of content items 130, any of the plurality of characteristics 132 may be associated with the plurality of content items 130, and each of those characteristics from the plurality of characteristics 132 may have any of a number of keywords 134 tagged for each of the plurality of content items 130.

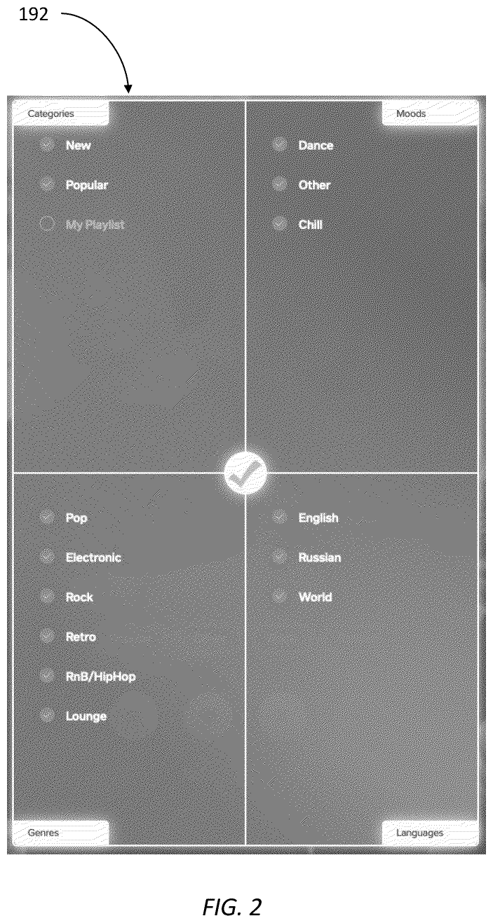

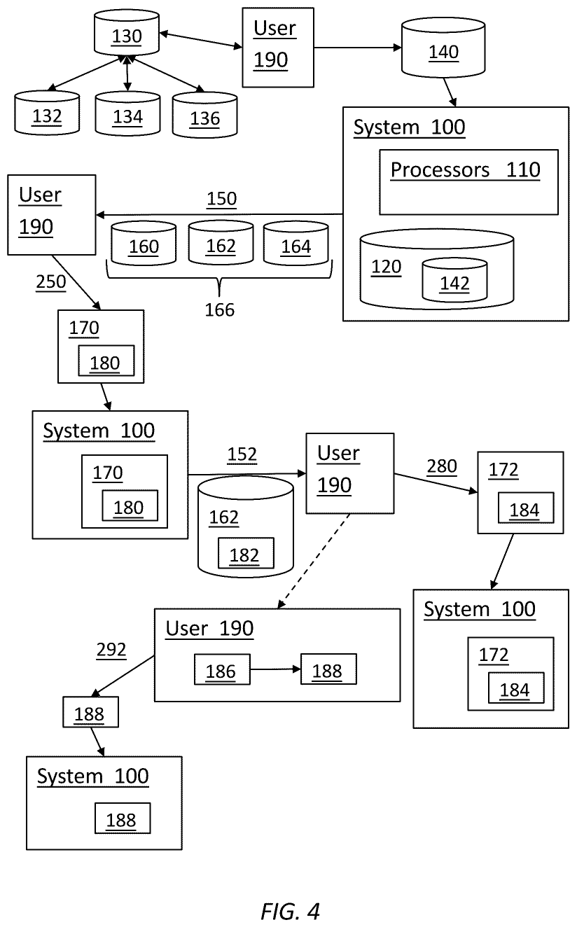

In the present disclosure, and with reference to FIG. 4, a user 190 communicates with the system 100 and in particular with the plurality of processors 110 to provide a plurality of user-selections 140 from the plurality of characteristics 132. With reference to FIG. 2, an exemplary possible user interface 192 is shown for the possible selections by the user 190 of the plurality of user-selections 140. The plurality of user-selections 140 are stored in the plurality of databases 120. The plurality of processors 110 provide a first output 150 of a second plurality of content items 160 from the plurality of databases 120 to the user 190. The foregoing disclosure, herein, regarding the plurality of content items 130, and the association of a plurality of characteristics 132 and any of a number of keywords 134 with the plurality of content items 130, is incorporated into the second plurality of content items 160. There may be any number, n, of pluralities of content items, such that they may be referred to as a third plurality of content items 162, a fourth plurality of content items 164, and so on for any number of pluralities of content items. Any such groupings of the plurality of content items 130, including but not limited to the second plurality of content items 160, the third plurality of content items 162, and/or the fourth plurality of content items 164, as streamed or queued to be streamed to the user 190, are referred to collectively as a feed 166.

Any of the plurality of content items 130 and/or the second plurality of content items 160, or other content items comprising the feed 166, may comprise any or all of music, video, audio music, spoken or other audio, news articles, any written works, social media posts, photographs, or other types of content, as disclosed herein.

The plurality of user-selections 140 stored in the plurality of databases 120 comprise multiple-choice selections from the plurality of characteristics 132. The plurality of databases 120 store the plurality of user-selections 140 as a plurality of content-tag-assignments 142, wherein the plurality of content-tag-assignments 142 comprise information generated by the user 190 about or related to the plurality of characteristics 132 and about or related to the any number of keywords 134.

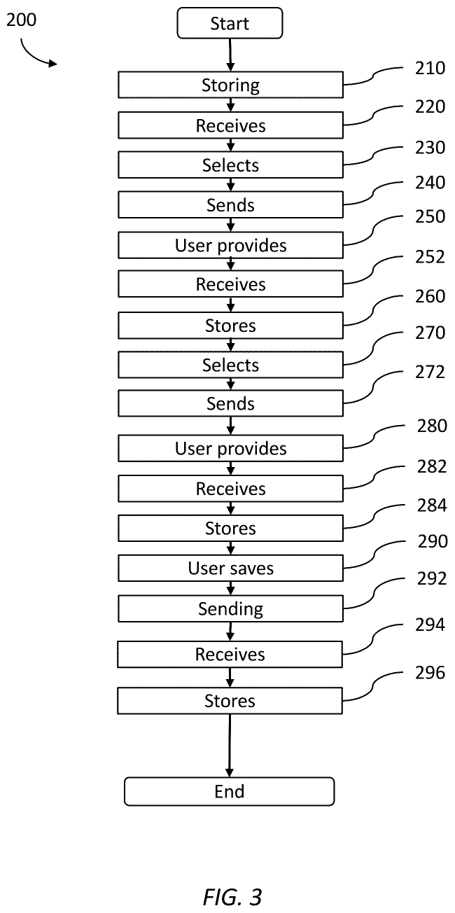

With reference to FIG. 3 and FIG. 4, the present disclosure comprises a method 200 for selecting a plurality of content items 130 for streaming, by a system 100, based on characteristics selected by a user 190 (or users) and/or based on feedback from a user 190 (or users), in any combination of such characteristics and such feedback. The method comprises the system 100 storing 210 the plurality of content items 130, wherein each of the plurality of content items 130 comprises the plurality of characteristics 132, the any number of keywords 134, and the plurality of user-content records 136.

The system 100 receives 220, from a user 190, a plurality of user-selections 140 from the plurality of characteristics 132. Each of the plurality of user-selections 140 comprises any of a number of keywords 134 for at least one of the plurality of characteristics 132. The option for the user 190 to make the plurality of user-selections 140 enable the system 100 to better serve the user 190 by providing a mix or combination of the plurality of content items 130, the second plurality of content items 160, or other groupings of content items, having one or more from the plurality of characteristics 132, including but not limited to content category, outputted sequentially or in new-sequential order into the feed 166 of the user 190.

The system 100 thereafter selects 230 a first output 150 from the plurality of databases 120 to the user 190, the first output 150 comprising a second plurality of content items 160. The system 100 thereafter sends 240 at least one content item 130 from the second plurality of content items 160 to the user 190, as at least some of the plurality of content items 130 comprising the feed 166.

In some aspects of the present disclosure, the method 200 thereafter comprises the user 190 provides 250 a feedback 170 on a first content item 180 from the second plurality of content items 160, and the system 100 receives 252 the feedback 170. The system 100 stores 260 the feedback 170 with the plurality of user-content records 136 for the user 190 and the first content item 180.

In some aspects of the present disclosure, the method 200 thereafter comprises the system 100 selects 270 a second output 152 from the plurality of databases 120 to send to the user 190, as at least some of the content items 130 comprising the feed 166. The second output 152 comprises a third plurality of content items 162, based on the plurality of user-content records 136. Thereafter, the system 100 sends 272 at least one content item 182 from the third plurality of content items 162 to the user 190, as at least some of the plurality of content items 130 comprising the feed 166.

In some aspects of the present disclosure, the method 200 thereafter comprises the user 190 provides 280 a feedback 172 on at least a first content item 184 from the third plurality of content items 162. The system receives 282 the feedback 172, and the system 100 stores 284 the feedback 172 with the plurality of user-content records 136 for the user 190 and the at least a first content item 184 from the third plurality of content items 162.

In some aspects of the present disclosure, the method 200 thereafter comprises the user 190 saves 290 at least a first content item 186 to a plurality of saved selections 188, sending 292 the plurality of saved selections 188 to the system 100. The system 100 receives 294 the plurality of saved selections 188, and the system 100 stores 296 the plurality of saved selections 188 with the plurality of user-content records 136 for the user 190 and the at least a first content item 186.

The present disclosure comprises a non-transitory, computer-readable media comprising instructions 300 operable, when executed by one or more computing systems, to cause the one or more computing systems to store a plurality of content items 130, where each of the plurality of content items 130 comprises a plurality of characteristics 132. The non-transitory, computer-readable media comprising instructions 300 are operable to cause a system 100 to receive a plurality of user-selections 140 from the plurality of characteristics 132. The non-transitory, computer-readable media comprising instructions 300 are operable to cause a system 100 to select a first output 150 from the plurality of content items 130 to be sent to the user 190. The non-transitory, computer-readable media comprising instructions 300 are operable to cause a system 100 to send at least one content item from the plurality of content items 130 to the user 190.

The various modules and/or functions described above may be implemented by computer-executable instructions, such as program modules, executed by a conventional computer. Generally, program modules include routines, programs, objects, components, data structures, etc. that perform particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The central computing device, also referred to as a processor, may comprise or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, the iOS operating system, the Android operating system, the Chrome operating system, an OPENSTEP operating system or another operating system or platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2, Pascal, Prolog, Python, Qt, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Herein, reference to a computer-readable storage medium encompasses one or more non-transitory, tangible computer-readable storage-media possessing structure or structures. As an example and not by way of limitation, a computer-readable storage medium may include a semiconductor-based medium or other integrated circuit (IC), including but not limited to a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. § 101.

The present disclosure encompasses all changes, substitutions, variations, alterations, and modifications to the example embodiments herein that a person having ordinary skill in the art would comprehend. Likewise, the appended claims encompass, where appropriate, all changes, substitutions, variations, alterations, and modifications to the example embodiments herein that a person having ordinary skill in the art would comprehend.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, although the foregoing embodiments have been described in the context of streaming items of content based on characteristics selected by users and/or based on feedback from users, in any combination of such characteristics and such feedback, it will be apparent to one of ordinary skill in the art that the invention may be used with any systems and methods for streaming items of content. The invention is thus not limited to any particular type of communication system, network, protocol, format, or application.

Some portions of this description describe the embodiments of the invention in terms of algorithms and symbolic representations of operations on information. These algorithmic descriptions and representations are commonly used by those skilled in the content-streaming, content-curation, and content-selection arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times to refer to these arrangements of operations as modules, without loss of generality. The described operations and their associated modules may be embodied in software, firmware, hardware, other code or location for code, or any combinations thereof.

Any of the steps, operations, or processes described herein may be performed or implemented with one or more hardware or software modules, alone or in combination with other devices.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Certain aspects of the present invention were described above. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those aspects described above, but rather the intention is that additions and modifications to what was expressly described herein are also included within the scope of the invention. Moreover, it is to be understood that the features of the various aspects described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. A system for selecting streaming items of content based on characteristics selected by users and based on feedback from users, the system comprising:
a plurality of processors;
a plurality of input/output modules; and
a plurality of databases comprising a plurality of content items, and a plurality of characteristics, and a plurality of user-content records; and
wherein the plurality of processors is communicably connected with the plurality of input/output modules and with the plurality of databases; and
wherein a user communicates with the plurality of processors to provide user-selections from the plurality of characteristics, the user-selections being stored in the plurality of databases, and the plurality of processors provide an output of a second plurality of content items from the plurality of databases to the user.

2. The system of claim 1, wherein the plurality of content items comprise any or all of music, video, audio music, spoken or other audio, news articles, any written works, social media posts, photographs, or other types of content.

3. The system of claim 1, wherein each of the plurality of content items may be associated with any number of the plurality of characteristics, and wherein each of the plurality of content items is stored in the plurality of databases with any of a number of keywords.

4. The system of claim 3, wherein the user-selections stored in the plurality of databases comprise multiple-choice selections from the plurality of characteristics, and the plurality of databases store the user-selections as a plurality of content-tag-assignments.

5. The system of claim 1, wherein the system is operated by an owner of the plurality of content items.

6. The system of claim 1, wherein the system is operated by an operator of a streaming service.

7. The system of claim 1, wherein the plurality of characteristics comprise types of content items, including but not limited to music, videos, animations, movies, news articles, any written works, social media posts, audio content, podcasts, audiobooks, or photographs.

8. The system of claim 1, wherein the plurality of characteristics comprise descriptors of one or more of the plurality of content items, including but not limited to category; genre; artist/author name(s); artist/author gender(s); artist/author age(s); languages, and/or a number of languages in the plurality of content items.

9. The system of claim 1, wherein the plurality of characteristics comprise mood; tempo; instrumentation; vocals or not; duration; length; year or year range made, written, and/or created, quality of the plurality of content items; written format; length; whether the plurality of content items includes pictures, video, and/or audio; content designated as violent, pornographic, and/or other graphic content; and/or type of creator.

10. A method for selecting streaming items of content, by a system, based on characteristics selected by users and based on feedback from users, the method comprising:
the system storing a plurality of content items, where each of the plurality of content items comprises a plurality of characteristics, and a plurality of user-content records;
the system receiving, from a user, a plurality of user-selections from the plurality of characteristics, each of the plurality of user-selections comprising any of a number of keywords for at least one of the plurality of characteristics;
the system thereafter selects a first output from a plurality of databases to the user, the first output comprising a second plurality of content items; and
the system sends at least one content item from the second plurality of content items to the user.

11. The method of claim 10, wherein the user provides a feedback on a first content item from the second plurality of content items, and the feedback is received by the system and stored with the plurality of user-content records for the user and the first content item.

12. The method of claim 11, wherein the system selects a second output from the plurality of databases to the user, the second output comprising a third plurality of content items, based on the plurality of user-content records; and the system sends at least one content item from the third plurality of content items to the user.

13. The method of claim 12, wherein the user provides a feedback on a content item from the third plurality of content items, and the feedback is received by the system and stored with the plurality of user-content records for the user and the content item from the third plurality of content items.

14. The method of claim 11, wherein the user saves at least a first content item to a plurality of saved selections, and the plurality of saved selections is received by the system and stored with the plurality of user-content records for the user and the first content item.

15. The method of claim 10, wherein the plurality of characteristics comprise types of content items, including but not limited to music, videos, animations, movies, news articles, any written works, social media posts, audio content, podcasts, audiobooks, or photographs.

16. The method of claim 10, wherein the plurality of characteristics comprise descriptors of one or more of the plurality of content items, including but not limited to category; genre; artist/author name(s); artist/author gender(s); artist/author age(s); languages, and/or a number of languages in the plurality of content items.

17. The method of claim 10, wherein the plurality of characteristics comprise mood; tempo; instrumentation; vocals or not; duration; length; year or year range made, written, and/or created, quality of the plurality of content items; written format; length; whether the plurality of content items includes pictures, video, and/or audio; content designated as violent, pornographic, and/or other graphic content; and/or type of creator.

18. A non-transitory, computer-readable media comprising instructions operable, when executed by one or more computing systems, to:
cause the one or more computing systems to store a plurality of content items, where each of the plurality of content items comprises a plurality of characteristics;
receive a plurality of user-selections from the plurality of characteristics;
select a first output from the plurality of content items to a user; and
send at least one content item from the plurality of content items to the user.
